(19) United States
(12) Patent Application Publication
(10) Pub. No.: US 2008/0163283 A1
(43) Pub. Date: Jul. 3, 2008

(54) BROADBAND VIDEO WITH SYNCHRONIZED HIGHLIGHT SIGNALS

(76) Inventors: Angelito Perez Tan, New York, NY (US); Kevin Lee, Shanghai (CN)

Correspondence Address: CONNOLLY BOVE LODGE & HUTZ LLP, P.O. BOX 2207, WILMINGTON, DE, 19899, US

(21) Appl. No.: 11/760,351

(22) Filed: Jun. 8, 2007

Related U.S. Application Data
(60) Provisional application No. 60/883,293, filed on Jan. 3, 2007.

(51) Int. Cl. H04H 9/00

(52) U.S. Cl. 725/20

(57) ABSTRACT

A broadband video layer is integrated with a separately encoded highlight layer configured for presentation in a first window of a video display. One or more visible objects in the video layer are associated with corresponding fitted highlight shapes in the highlight layer. Appearance of the shape object in the video layer is synchronized to appearance of an associated highlight shape to define highlight events. A context may be defined for each highlight event. Occurrence of highlight events may be represented by icons or markers in a video progress bar. Contextual information may be presented in a second window synchronized with the highlight events.

### BACKGROUND

1. Field

The present disclosure relates methods and apparatus for providing broadband video for play on a computer having a video display output.

2. Description of Related Art

Traditionally, video content has been delivered to consumers via non-interactive media, such via television broadcasts, or by distribution of content to consumers or movie theaters on various media, such as video tape, DVD, or film. More recently, video has been delivered via interactive media such as for play on a computer having a video display output. Implementations of video content servers configured for streaming video content to computers via a broadband connection have recently become extremely popular. Websites offering streamed video content may attract millions of users desiring to browse, select and view content accessed via a website. Such sites may be supported by advertising placed on the site's web pages, such as banner ads, pop-up ads, or the like, or “streamed-in advertisement” included in the video clips themselves. All of these types of advertisements may be sold to third-party advertisers to generate revenue from on-line video, and thereby support the costs of providing the content to consumers.

Nevertheless, realizing a profit from offering online video content is not without its challenges. One challenge is that advertising associated with online video is in essentially the same format as competing advertising offered via traditional video distribution or World Wide Web page content. So far, age-old streamed-in advertisement or web page advertisements are the only revenue generators for online video, and these advertising platforms are not distinctly different or more compelling than what is available on traditional video media such as television or on websites that do not supply video content. The popular model is to use stream-in advertisement before or in between videos, and very little has been done to use the actual video content itself as a platform to sell products. Thus, traditional advertising platforms do not make new or innovative use of capabilities offered by online video distribution in an interactive computing environment, due to unsolved technical problems and an accompanying lack of creative design.

For example, while it is recognized that contextual advertising is generally effective, it is difficult to implement contextual advertising for videos. Unlike textual content such as HTML, web pages, or blog pages, videos generally cannot be analyzed by algorithm to determine targeted advertising content. The result is low click through rates and poorly performing ads, especially when factoring in the high costs of bandwidth for videos in comparison to text content.

A variant of contextual advertising, sometimes referred to as “product placement,” is known in traditional video production. In product placement advertising, an advertiser designates a product that will appear as part of the video production, either as a prop or background used in a scene, as a product mentioned in dialog, or both. Such placement can provide brand exposure and if properly designed, may induce some viewers of the video to purchase the video-placed product. However, product placement in online videos has to date operated essentially the same as it does in traditional video platforms. Online videos have not presented product placement any differently than in traditional media, nor have made effective use of product placement in conjunction with interactive aspects of the computer viewing platforms on which online videos are watched. Again, the result has been advertisements that do not perform as well as desired and that may not adequately support the production and distribution of online video content in comparison to lower-bandwidth, lower-cost content.

It is desirable, therefore, to provide a method and apparatus for presenting contextual information in conjunction with video content that overcomes the limitations of the prior art. In addition, it is desirable to present advertising more effectively as contextual information in an online video for play on an interactive computing platform.

### SUMMARY

The present disclosure is directed to methods and apparatus for producing and presenting video data on display screens of interactive devices in association with highlights for objects appearing in the video data and contextual information, such as advertising, that appears on cue with highlights occurring in the video data. A video may thus be prepared in which product placements or any other desired object are highlighted in a noticeable way that does not intrude on enjoyment of the video data. Likewise, presentation of the contextual information may be cued to occurrence of highlights in the principal video. In an effective implementation of this disclosure, the contextual information adds interest to the principal video, while the principal video adds interest to the contextual information, and the viewer is free to focus on whatever items are of greatest interest at each moment of the video. Thus, a synergistic effect can be created between the video and any accompanying contextual data, to provide more compelling and interesting educational materials or advertising.

Highlights may be implemented in an overlay that fires in sync with a separately encoded video file. Advantageously, the highlights need not be hard-encoded into the principal video, and thus, may be added in a video post-production process for broadband network distribution or other interactive format. Highlights may be given any desired appearance. In some implementations, it may be advantageous to configure highlights as flickering objects appearing near an object in adjacent frames of the principal video. The duration of the flickering object may be very brief, for example, 3-10 frames. A brief duration of flicker may minimize obtrusiveness and video synchronization issues, while the flicker itself remains noticeable to most viewers.

Video content may also include a subject index bar, which may contain thumbnail images of all the subjects highlighted in the video. In addition, a player for the video content may include or be integrated with contextual information concerning subjects highlighted in the video. As the video is playing, the active subject in the index bar and the second window may update in synchronization with cues embedded in the video. Highlighted subjects may include commercial products placed in the principal video data during a production process, and contextual information may include advertising for the commercial products and hyperlinks to further information or to a site configured for selling the highlighted product. In the alternative, or in addition, highlighted subjects may include non-commercial objects, and contextual information may include educational or imaginative exposition of highlighted objects.

For advertising applications, the subject index bar may be configured as a floating column of product thumbnails over the video that enables the user to navigate through the different products in the video in any desired sequence and use the video player in a more interactive manner. Clicking on an item in a product index bar may trigger the product window to display the selected product. Likewise, the user may be enabled to make purchases directly via the second window or find out more information such as prices, availability, description, or more photos. The second window containing product information may also allow the user to navigate between the different products embedded in the video and include a function enabling a user to jump to a part of the video where the particular product is displayed to view the product in the context of the video. Similar navigational functions may also be implemented for applications other than advertising.

A video progress bar may similarly be provided with the video content, having markers indicating cue points for highlights appearing in the principal video data. By manipulating a slider or pointer, a user may jump to the cue points to see the highlighted object.

The video content may be produced to seamlessly embed contextual information, including product data and advertising, or metadata into the video. More specifically, using a technology that embeds visual cues for product information and integrates a user interface that facilitates purchasing, separately produced video content may be used as a medium for product display and promotion. Product highlights and presentation of contextual information such as advertising may be customizable so that the user may decide how visible they will be.

In embodiments of the technology, object highlighting may be implemented using a flicker method as disclosed herein. The flicker may be adopted to highlight elements in the video and allow the identification of products that containing embedded information. A flicker may be designed to have various advantages, such as, for example, being:

1) Non-intrusive. The highlighting of objects in the video may be adjustable and faint, so the flicker may be turned off or set so it does not distract viewers that may not be interested in embedded contextual information.

2) Pushed to the user. The technology may be designed to actively push information and cues to the end user. Thus, the user does not need to take action to access the information, or try to identify which areas of the video contains embedded information. This may be especially useful for fast moving videos, such as music videos, where a rapid pace of movement makes clicking on objects in the video difficult or impossible.

3) Highly synchronized with the underlying video layer without hard-encoding the flicker into the video itself. Presently, commercially available online video streaming technology is not able to synchronize every frame of independently-encoded video data. For example, Adobe Flash™ technology is incapable of the synchronized firing of a FLV layer with overlaying flash SWFs by the frame—it is only able to synchronize the firing of both layers to the maximum accuracy of 1 sec. after the 1st frame. In a fast-moving video, too large a deviation between layers, for example, more than approximately 0.2 seconds, may cause a noticeable breakdown of synchronization. Without good synchronization, video output may be confusing or contain undesirable distractions from lack of synchronization.

To overcome present video streaming technology limitations, a flickering highlight may be designed to be very brief in duration, such as 3 frames, to keep sync issues in check. However, a 3 frame flicker may be difficult to spot because it lasts only about 0.10-0.15 seconds at typical frame rates of 20-30 frames per second for the principal video. A flicker design as disclosed herein ensures both a high degree of synchronization with the base video as well as being fairly easy to identify (while remaining unobtrusive), even when lasting for only 3 frames or about 0.10-0.15 seconds, although it may last longer.

A more complete understanding of the broadband video with synchronized highlight signals will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a schematic diagram showing aspects of a system for distributing and using broadband video with synchronized highlight signals.

FIG. 2 is a block diagram showing aspects of broadband video with synchronized highlight signals and components of a system for serving it.

FIGS. 3-12 are screenshots showing exemplary aspects of video content with synchronized highlight signals as displayed on a display device.

FIG. 13 is a schematic diagram showing aspects of a data structure for video content with synchronized highlight signals.

FIG. 14 is a flow chart showing exemplary steps of a method for providing data for a video output with synchronized highlight signals.

In the detailed description that follows, like element numerals are used to indicate like elements appearing in one or more of the drawings.

### DETAILED DESCRIPTION OF VARIOUS EMBODIMENTS

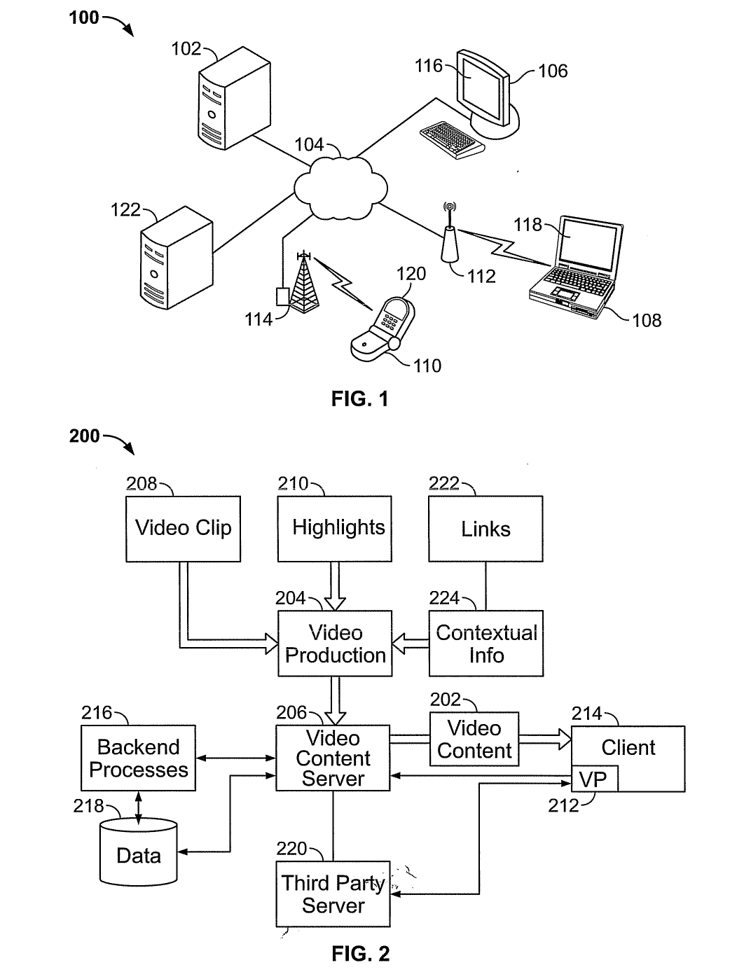

FIG. 1 shows a system 100 for distributing and using broadband video with synchronized highlight signals. A video server 102 may store and serve video content via a connection to a wide area network 104 such as the Internet, using any suitable protocol such as, for example, TCP/IP through a World Wide Web interface. The server 102 may service requests for content from any number of remote clients, for example, requests from a client computer 106 via an Ethernet connection to an Internet host, from a portable computer 108 via a wireless access point 112, or from a mobile phone/computing device via a wireless cellular network 114. Any suitable client may connect to server 102; a suitable client is one capable of running a video player application to play the requested video content and produce video output on a display screen. For example, client devices 106, 108, 110 are equipped with internal processors capable of running a video player application for requested video content to produce video output for viewing on display screens 116, 118, and 120, respectively. System 100 may include other network components as known in the art.

System 100 may further include a backend process server 122 for handling requests from remote clients originating from video content links. Video content may be provided in association with links to third-party or backend processes, for example, a third-party site providing further information about a product appearing in the video, or a backend process for processing an order for a product appearing in the video.

FIG. 2 shows aspects of exemplary video content 202 with synchronized highlight signals in a system 200 for providing and servicing the video content. The video content may be produced using a video production process 204 and stored as known in the art for distribution from a video content server 206. Production of a principal video clip may be performed separately as known in the art; production process 204 is generally concerned with enhancing separately-produced video content and configuring it for use with a video player 212 on a client 214 according to the technology described herein. For example, the video clip 208 may comprise a music video, dramatic program, sports program, documentary, recorded live production, or any video content of interest to potential viewers. The video production process 204 integrates such principal video content with secondary video content 210 used to highlight discernable shapes or objects that appear in the principal video 208.

Secondary video content or “highlights” 210 may be defined in an editing or administrative process based on defined targets in the video clip 208. Defined targets may include images of commercial products present in the video clip, or any other image appearing in the video clip for which it is desired to present advertising or other contextual information. A highlight 210 may comprise a defined shape or bit map located in a frame so as to superimpose over an image in the video clip for a defined number of frames, for example, 3, 4, 5, 6, 7, 8, 9 or 10 frames. The highlight may change in appearance in each frame or over several frames, and may appear to flicker. Flickering may be employed as an intentional visual effect to make a highlight that appears very briefly in the video more noticeable. The highlight may appear in a different video layer than the video clip. As known in the art and as used herein, “layer” does not necessarily connote or require a separate physical layer such as a layer of film stock. In a computer graphics environment, a layer merely connotes a set or group of graphics data that is referenced to a common identifier and that may be manipulated (e.g., rotated, scaled, deleted, shaded) together. A video output file may be comprised of several such layers that may appear together in each frame of the video. Defined rules based on an ordering of the layers and properties of objects in the layers, such as transparency, may be used to determine what part of each layer is actually visible in each frame of the video.

Contextual information 224, such as advertising, factoids, or menus, may be imported or defined and linked to highlights 210 or other features or events in the video, such as by using cue points embedded in the video file. Contextual information may include, for example, graphics files or images, text, HTML or XML documents. Contextual information may relate to objects in the video that are highlighted using highlights 210. Cue points for contextual information should be synchronized with the appearance of a highlight for the object to which the contextual information relates.

Contextual information may include or be associated with links 222, for example hyperlinks or active objects for requesting further information or applets from a video content server 206 or third party server 220. When a user selects or activates a link, the user may be presented with the further information in a window of a client display.

In some embodiments, Adobe Flash™ technology and the Adobe FLEX2™ platform may be used to implement a front end 206 for access by participating clients, or in other words, to configure and play the video content 202. These technologies currently allow for programming logic to be embedded into or layered on top of the video content. Embedding allows for synchronized triggering of flickers, factoids, highlights, and other objects in multiple video layers. These capabilities are currently difficult to implement using traditional streaming technologies such as RealMedia™, Windows Media™, or QuickTime™. Under the Flash/FLEX platform the video forms an essential part of the web application, which allows for interactivity and connectivity with web pages and integrated database functionality. While Flash Actionscript may be used for the movie layer and embedding, similar but currently less capable approaches may include using Quicktime (and its associated programming libraries—such as in VideoClick.com) or using a custom built video player client that users need to download, or any suitable player such as may be available in the future.

In an exemplary Flash™ implementation, an original video clip and the contexual information may be imbedded in different overlapping layers of integrated compatible graphics files, such as in an SWF file. One layer, for example, may be used to embed product cues in the form of a transient flicker. The duration of the flicker may be very brief, such as less than a second, although longer flickers or other highlights may also be used. The integrated video content (such as an SWF file) may then trigger events in corresponding parts of the interface to display product information and purchasing components. Other overlapping layers can embed other information, such as lyrics, menus, interfaces for tagging and mailing, product bars, or other features that appear with or are accessible with the principal video clip. The user may be given an option to deactivate specific features that may be implemented in a layer or “overlay” of the video content.

Thus, video content as described herein may be implemented via a combination of Flash Actionscript™, Javascript™, AJAX (asynchronous javascript and XML) and any suitable server side programming language. These technologies may be used to provide a connectivity layer between a front end with a full motion video component 202 and traditional backend technologies 216, such as, for example, relational databases 218, business logic, and secure transactions servers. Selected third-party e-commerce sites 220 partnering with the video content server for order fulfillment may be connected seamlessly to the video content server website 206 through APIs or other connectivity methods. In addition, or in the alternative, third-party sites 220 may communicate directly with client 214.

A video player application 212 for clients to play video content may be configured as a database driven application with multiple access points to back end data 218. The player application may thereby be configured to implement various functions, such as, for example:

1. Instant sharing of the video via email, social networking, social news, or social bookmarking sites;

2. User-driven folksonomy enabling tagging of the video or the products by the community;

3. Activating and deactivating specific overlays or metadata, such as lyrics, factoids, or a product flicker/highlight;

4. Displaying contextual advertising banners based on the tags or other metadata available on the video;

5. Tracking user behavior;

6. Allowing for playlist functionality; and/or

7. Allowing users to store products in a “shopping cart” without going to a webpage interface first.

In current applications, Adobe Flash and Adobe ActionScript do not provide the ability to synchronize the playback of the FLV (video loaded into the Flash SWF) and the Flash SWF. Instead, the FLV video comprising the principal video clip and the Flash SWF layer containing the highlight flicker are run at different frame rates. Depending on available system resources and conditions, a selected frame in the SWF highlight layer can be synchronized with a defined frame in the FLV layer, but the following frames will not be. After a relatively small number of frames have played on the client video player, the FLV and SWF layers may become noticeably desynchronized.

ActionScript may include a CuePointManage feature that may be applied to synchronize the FLV video clip and the SWF layers so that they fire on the same starting frame. Once a flicker highlight begins to play, the ActionScript FRAME and TIMER events may be used to control the per-frame “bursting” of the flicker animation. This method of control may effectively minimize de-synchronization that might otherwise occur between the SWF and FLV. In practice, however, this method may not remove de-synchronization completely. Currently, there is nothing in Flash that ensures that a sequence of frames on the SWF and the FLV is synchronized frame per frame, and Flashplayer as currently implemented does not maintain a constant frame rate during the course of FLV playback. Instead, the framerate changes based on network system conditions and resources. Hence de-synchronization of the flicker and the video may still occur.

An effective flicker or highlight that works within technology limitations should be implemented. One useful flicker is executed within 4 frames, so that any artifacts caused by synchronization are minimized and generally unnoticeable, while each flicker remains visible enough to highlight the product. It may be difficult to construct a highlight that is visible enough to be noticeable without interfering with enjoyment of the underlying video, while maintaining synchronization with it. Care should therefore be taken to construct an effective highlight in the current Flash environment. If working in an environment that permits synchronization of different video layers, a wider range of highlight designs, for example highlights that are more subtle in each frame but that appear for a greater number of frames, may also be suitable.

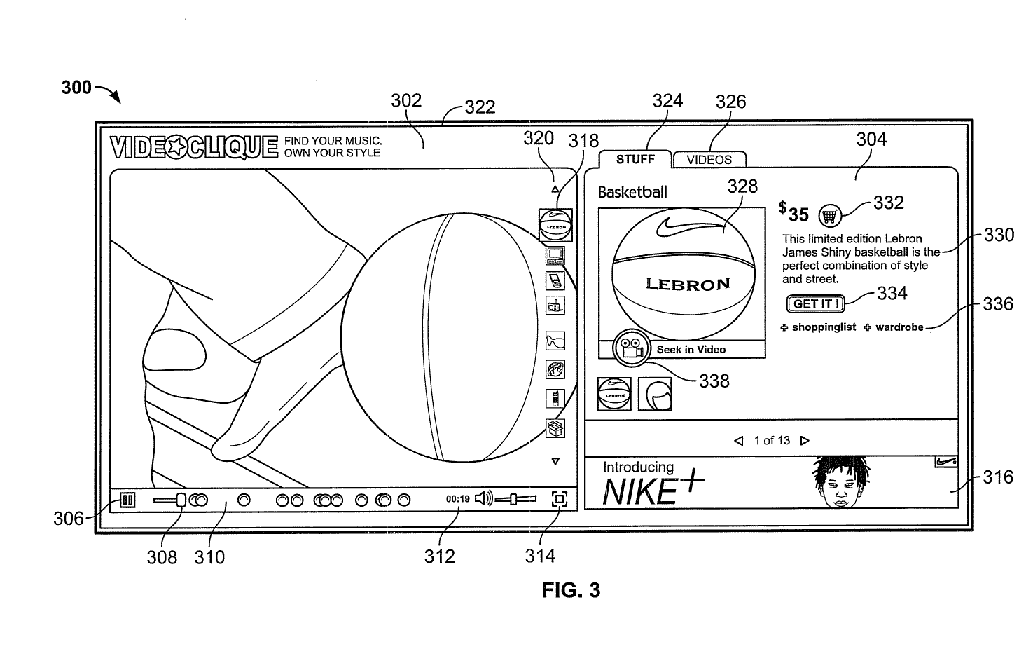

FIGS. 3-12 are screenshots showing exemplary aspects of video content with synchronized highlight signals as it may be displayed on output device using a video player application. FIG. 3 shows an exemplary screenshot 300 including a video window 302 for displaying the principal video and a product window for displaying advertising or other contextual information cued to products, persons, or objects appearing in the principal video. A video player application may also provide controls for video content, for example a play/pause toggle control 306, a loudness control 312 and a full screen/partial screen toggle control 314. The interface may include a progress bar 310, which may include a slider 308 and that may include markers for cue points. In this example, the markers are circular marks placed on the progress bar and indicate where highlights will appear in the video. By moving the slider, a user may start the video play from a particular point in the video clip.

The product bar 318 on the right of the video window 302 shows a thumbnail image of all the featured products in the video. The current product, in this case a basketball, is shown in an emphasized thumbnail 320. The emphasized thumbnail may change at each cue point to show the current highlighted product. Each thumbnail image may also act as a control for jumping to a particular point in the video. For example, by selecting another image in the product bar, a user may cause the video to jump either forwards or backwards to the cue point associated with that image. The product bar 318 may include a control, such as a scroll control 322, for scrolling through the various products depicted on the bar.

The product window 304 may be associated with a selection tab 324 for bringing that window to the foreground. Other tabs may be provided for other windows, for example, a tab 326 for bringing up a video selection window and other tabs (not shown) for bringing up a playlist window or other window. The product featured in the product window may be synchronized with events in the video window. For example, screenshot 300 shows an exemplary video player interface as it might appear shortly after a cue point for the basketball product has been encountered in the video clip. A highlight flicker has already passed and is no longer visible in the video window. The product window 304 includes an image 328 of the basketball appearing in the video, and text 330 describing the product. The price of the product may be displayed along with links for purchasing the product 332, checking a shopping cart 334, and other back end processes.

The product window 304 may also include one or more links 336 for viewing a list of products and associated information concerning products related to the video, for example items appearing in an actor's wardrobe. Selecting such links may enable a user to view and purchase products that are not highlighted in the video but that are related to a highlighted product or some part of the video in some way. The product window may also include a link to enable a user to cause the video to jump either forwards or backwards to a cue point associated with the product shown in the product window.

The interface may include content that is not cued to the video clip, or that is not related to products shown in the clip. For example, the video player interface may include a dedicated space 316 for traditional banner advertisements or other content.

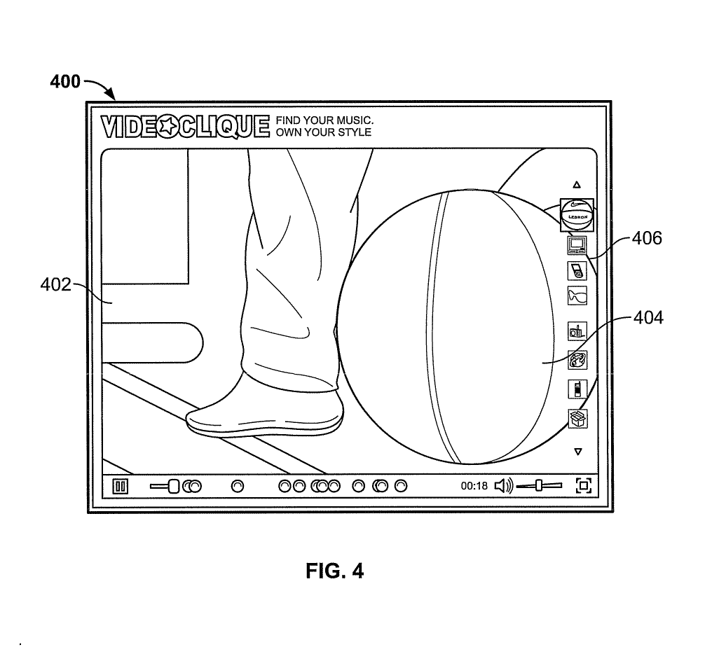

FIG. 4 shows an exemplary part of a screenshot 400 including a video window 402 in which a highlighted product 404 and a flicker highlight 406 appears. The flicker highlight appears, in this example, as a translucent overlay over the highlighted object, in this case, a ball. The duration of the overlay may be very brief, such as a single frame, and may change in adjacent frames to cause a very brief flicker over or near the ball. Other highlights may also be effective, such as an aura or outline around a highlighted object.

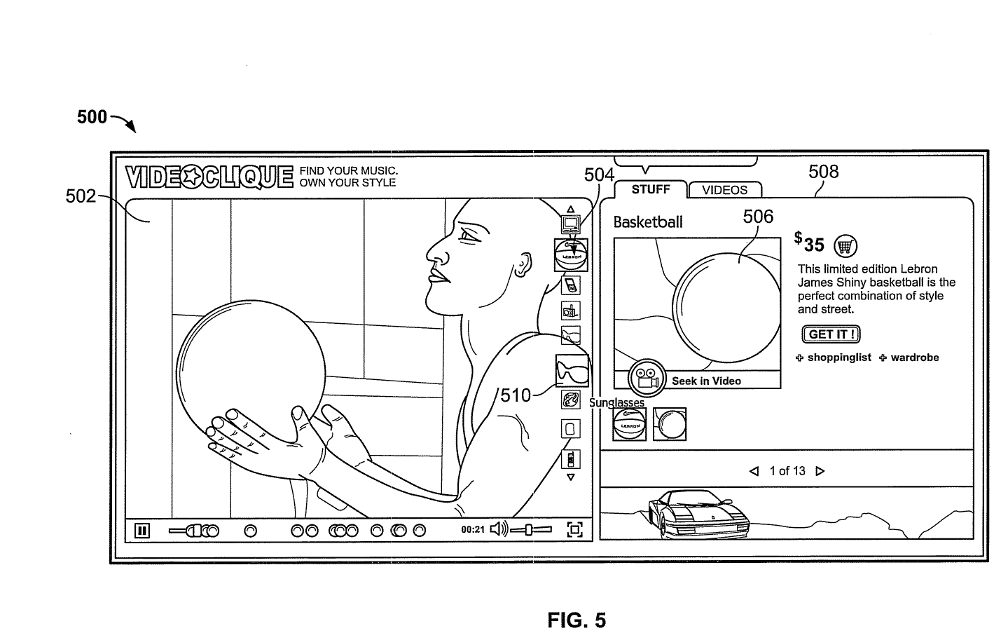

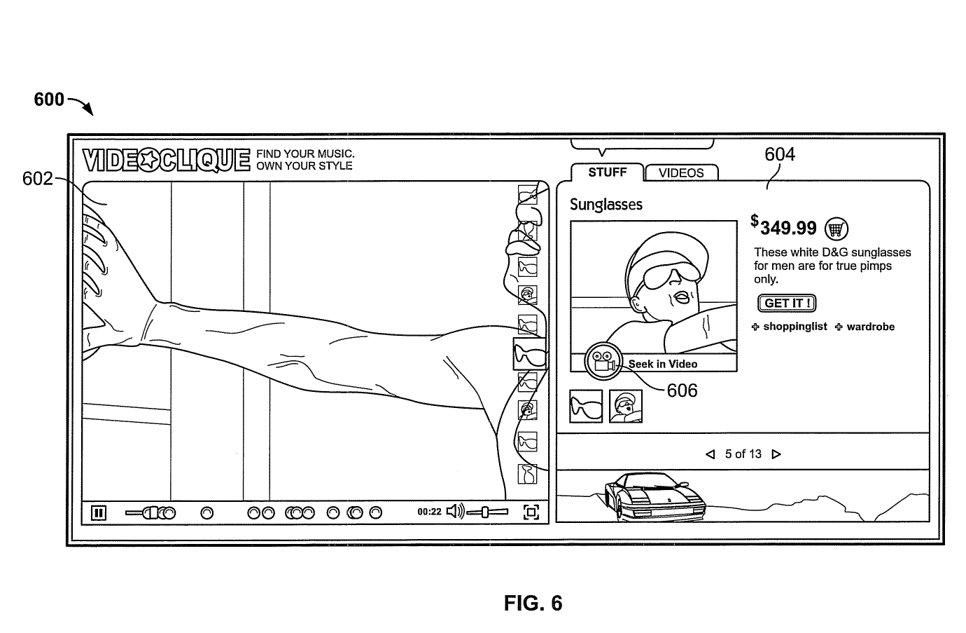

FIGS. 5 and 6 exemplify operation of a product bar. FIG. 5 shows an exemplary screenshot 500 in which the video window 502 includes a product bar 504 at a time in the video clip when the basketball 506 is cued in the product window 508. The screenshot shows what may happen when a user moves a cursor over another item on the product bar. In this example, the user has moved a cursor over a thumbnail image 510 of a pair of sunglasses, causing an emphasized (e.g., no longer grayed-out) image of the sunglasses to appear on the product bar. At this point, the ball sill appears in the product window.

FIG. 6 shows a screenshot 600 of what may happen when the user selects the emphasized image 510, such as by clicking or double-clicking on it. In this example, the video in the video window 602 does not jump to the cue point associated with the sunglasses. The product window 604, however, shows the sunglasses graphics and product description. At this point, a user may select the product jump button 606 to jump to the cue point associated with the sunglasses. In the alternative, the video may jump to this cue point immediately after the sunglass thumbnail 510 is selected on the product bar.

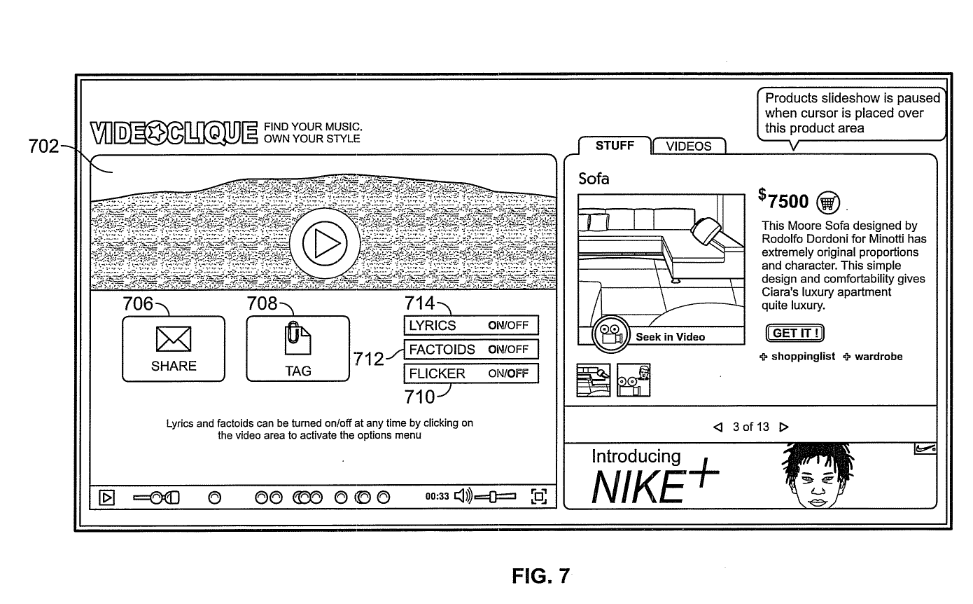

FIG. 7 shows an exemplary screenshot 700 of a control panel window 702 which may appear before or after a video is played in the video window, or by selecting a control icon. The control panel may include various controls for changing the display or manner in which the video content is played, or for accessing additional features provided by the video player interface, of which the depicted controls 706, 708, 710, 712 and 714 are merely exemplary. In a Flash™ implementation, controls may be used to set control variables used by an SWF script to determine whether or not SWF components, such as highlights, lyrics, factoids, and so forth are played. Controls may also be used to provide access to features not directly related to or contained in the video content, such as email or tags.

Controls 706 and 708 exemplify the latter type of controls. By selecting a message control 706, the user may access an email or instant messaging application for communicating with other users. By selecting a tag control 708, the user may access a tagging application for associating tags or comments with video content, for the user's own reference or for reference by system users generally. Applications such as messaging or tagging may be implemented as back end processes from the video content server or an alternative process from a third party server. Calling up a back end process or alternative process may cause video playback, downloading, or other front end process to pause while the back end or alternative process is run.

Controls 710, 712, and 714 exemplify controls for controlling how a video is played, for example, in a Flash implementation, for setting control variables in an SWF file. Highlight control 710 may be used to control whether or not a flicker or other highlight is visible during play of the principal video. By selecting this control, a user may toggle on or off a highlight layer of the video content. Factoid control 712 may be used to toggle on or off a factoid layer, which is described in more detail below. Lyrics control 714 may be used to toggle on or off a window displaying lyrics (in a music video) or subtitles.

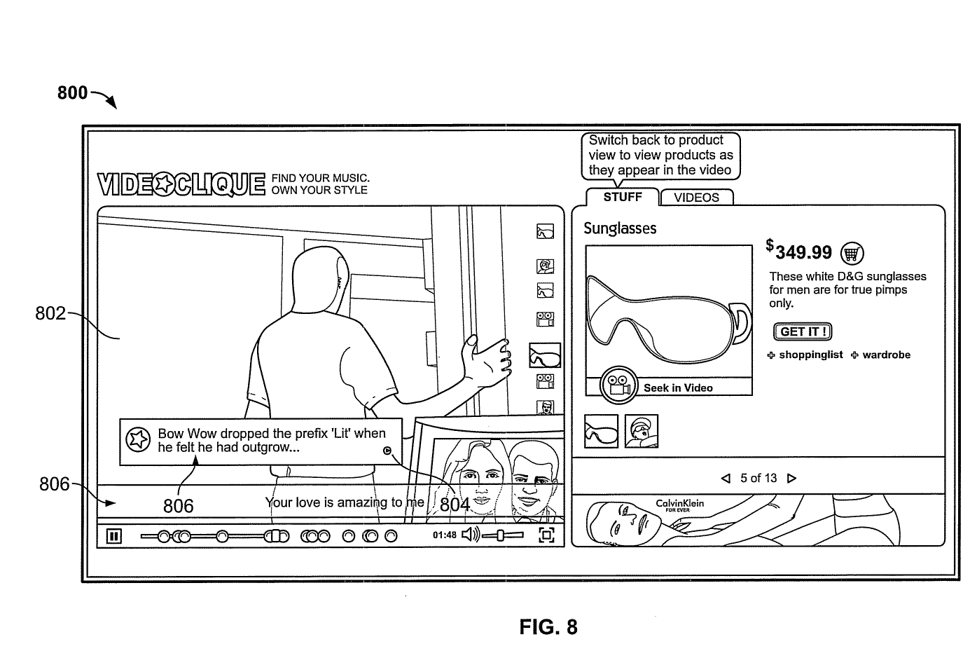

FIG. 8 shows an exemplary screenshot 800 of a video window 802 in which a factoid link 804 appears. The underlying video may contain various factoid links that are cued to appear at corresponding cue points of the principal video clip. The viewer may control the appearance of factoid links by enabling or disabling a factoid control 712 as shown in FIG. 7. When the factoid control is enabled, each factoid link, e.g., link 804, will appear at a corresponding cue point for a defined period, and then disappear. If the factoid control is turned off, no factoid links will appear. Factoid links may comprise a title or other text describing the factoid, or excerpted from the factoid. Factoid link 804 shows text 806 from the first few lines of an associated factoid. By selecting the link 804, a user may view the full text of the factoid.

FIG. 8 also shows a lyrics or subtitle window 806 that may appear in or near the video window 802. The underlying video content may comprise song lyrics or subtitles that are cued to appear at corresponding cue points of the principal video clip. The viewer may control the appearance of lyrics or subtitles by enabling or disabling a lyrics/subtitle control 714 as shown in FIG. 7. When the lyrics/subtitle control is enabled, lyrics or subtitles will appear in a window 806 at a corresponding cue points for a defined period, and then disappear. If the lyrics/subtitle control is turned off, no lyrics or subtitles, as the case may be, will appear.

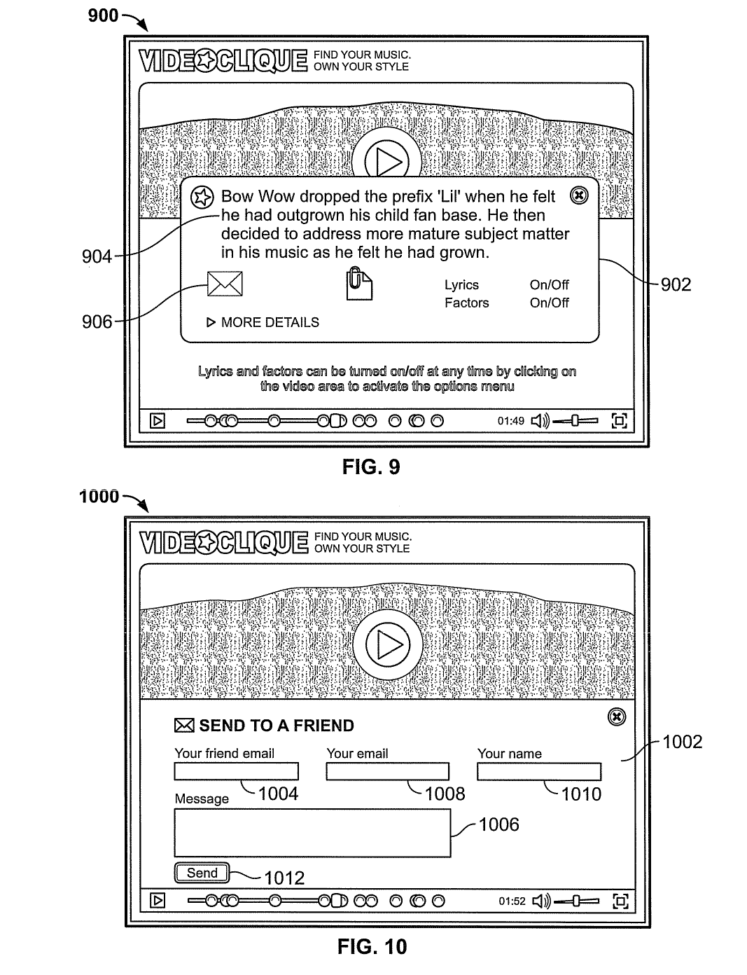

FIG. 9 shows an exemplary screenshot 900 of a factoid window 902 including text 904 that may appear when a user selects a factoid link 804. As used herein, a “factoid” is a concise paragraph or a sentence of text concerning a fact, unverified information or opinion relating to some person or object appearing in the principal video. The factoid may be presented with a link 906 to an email or other messaging application for sending the factoid to another user.

FIG. 10 shows an exemplary screenshot 1000 of a messaging window 1002 that may be used to send messages to any person having an email address or instant messaging ID. A destination field 1004 may be used to indicate an addressee for a message to be sent. The message may be entered into a message field 1006. Optionally the used may indicate a return address or name using fields 1008, 1010. In the alternative, such data may be supplied by default or omitted. After a message is prepared, a user may transmit the message by selecting a “send” control 1012, which may cause the video player to dispatch the message to the indicated address. The messaging window may be accessed by selecting a corresponding control from an interface skin of the video player. An exemplary messaging control 706 is shown in FIG. 7.

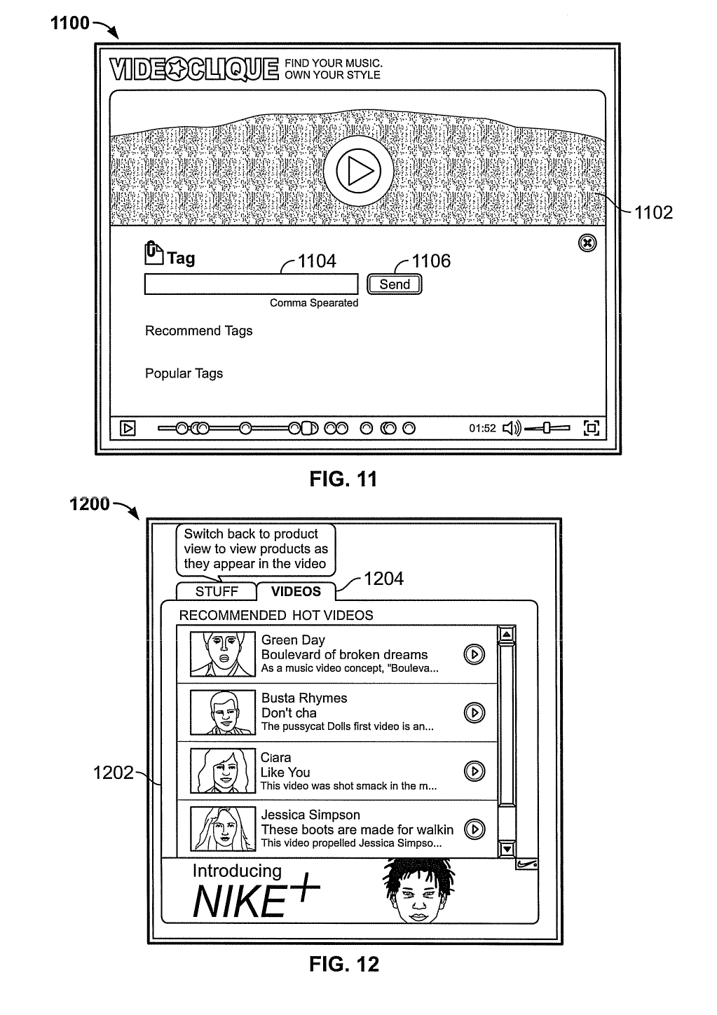

FIG. 11 shows an exemplary screenshot 1100 of a tag entry window 1102 that may be used to tag a particular video with any key terms, phrases, or comments selected by a user. Tags may be input into a form entry object 1104 and uploaded to a database using a “send” control 1106. Once uploaded, the tags may be accessed by other users to identify popular videos or share comments with other users. Each tag may be associated with the video loaded into the video player at the time the tag is entered. The tag entry window 1102 may be accessed by selecting a control from the home screen of the video player while a video clip is playing or otherwise loaded into the player. An exemplary tag control 708 is shown in FIG. 7.

FIG. 12 shows an exemplary screenshot 1200 of a video selection window 1202 that may be displayed to permit user selection of alternative videos. The selection window may show icons and descriptions of other videos present in the video server database and available for viewing. By selecting an entry in the list, the user may cause the video player to download and play the corresponding video from a video server library. A user may cause the list to appear by selecting a video window control 1204. A user may also specify search terms or other criteria to limit the list of videos to clips of particular interest. A similar window and link may be used to allow a user to organize videos into one or more playlists.

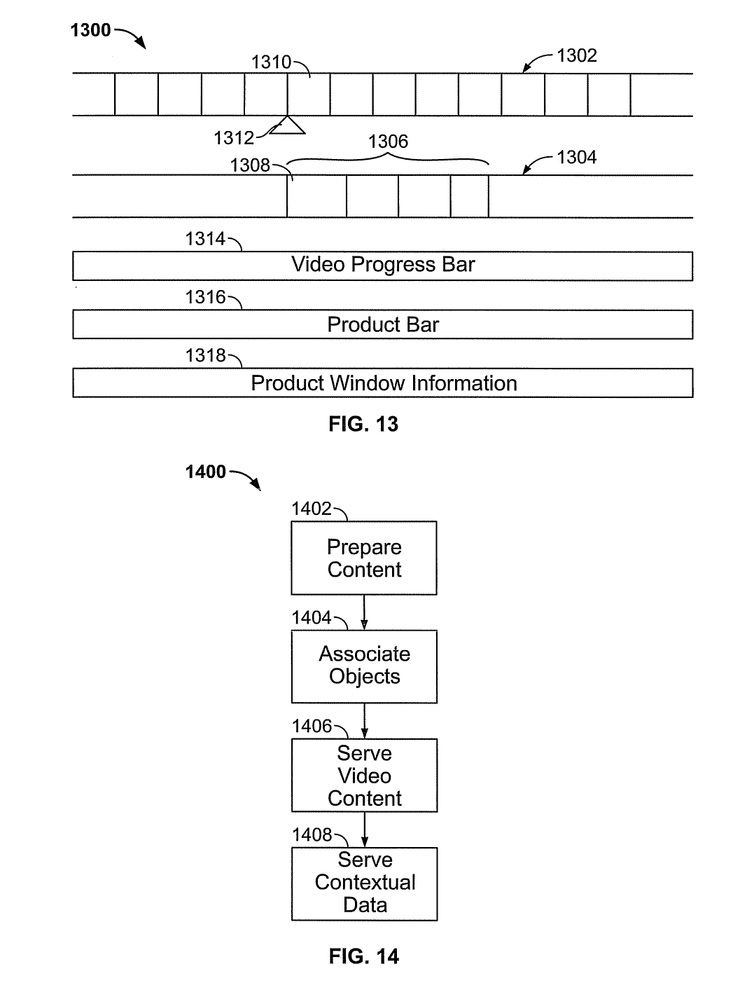

FIG. 13 is a schematic diagram showing aspects of a data structure 1300 for video content with synchronized highlight signals. When played in a suitable video player on a client machine, the data structure 1300 may cause a video output as described herein. Data structure 1300 may comprise a first, principal video clip layer 1302 comprising a plurality of logical frames that are played in sequence to cause a video output on a client machine. A second, highlight layer 1302 contains sets of highlight frames 1306 (one of many shown). A first frame 1308 of the set 1306 in the highlight layer 1304 is synchronized to a selected frame 1310 of the video layer 1310. A cue point 1312 in the data structure may be used to indicate the selected frame 1310. The data structure may comprise numerous other cue points (not shown) to indicate other frames of the video layer to which other events may be cued. Each cue point may be used to indicate an initial frame of a sequence in which a product or other object appears for which contextual information 1318 is provided in a product window. Each cue point also indicates a frame where a product or other object is highlighted.

The data structure 1300 may also include a video progress bar 1314. The video progress bar may be configured to periodically refresh itself to show progress of the video playback. That is, the progress bar may provide a graphic illustration of how much has played and remains to be played. The bar may include markers that coincide with cue points in the data structure, e.g., cue point 1312. The progress bar may include a slider or pointer that can be moved on a client video player interface to change the current frame of the video playback.

The data structure may also include a product bar 1316 that may be responsive to cue points in the structure. For example, the product bar may comprise a series of thumbnail images of products appearing in the video layer 1302. Each time a cue point is reached in the principal video 1302, a corresponding one of the thumbnail images may be enlarged or otherwise emphasized. Each thumbnail image may further be configured as an active object allowing a viewer to navigate to a corresponding cue point of the video clip. For example, by clicking on the thumbnail image of a particular product, the viewer may cause the video player to jump to a cue point corresponding to that product.

The data structure 1300 may further include contextual information 1318 responsive to cue points. In the alternative, the data structure may include pointers or identifiers for contextual information, and not the contextual information itself. As the each cue point is reached, the pointer or other indicator may be used by the player to fetch contextual data from a database, which may be a remote or local database. The player may then cause the contextual information to be displayed in a window or portion of display screen area on the client video display. The data structure 1300 may further include other information cued to video frames or cue points, for example, song lyrics, subtitles, factoids, factoid links, product links, or any other information that may be related to video content.

According to the foregoing, a method 1400 for providing an interactive video display output may be performed using exemplary steps as shown in FIG. 14. Method 1400 comprises preparing 1402 digital video content. Digital video content may comprise first and second video objects that are not encoded together. Preparation may include configuring separately-encoded files or data for display together in overlapping layers. A flicker or highlight layer may comprise a partially-transparent layer that is empty except for a highlight appearing over or adjacent to a product to be highlighted in a second, underlying layer. The layers may be combined for display in a first window of a client video display, such as, for example, in the view frame of a media player operating on a client computer. For example, the layers may be defined in an SWF file. At least one visible object shape in the first video object should be associated 1404 with a fitted highlight in the second video object. The highlight may be synchronized to appear with and draw attention to the visible object shape during a highlight event.

The first video object may comprise an FLV file or other encoded video clip. The second video object may comprise a shape defined in an SWF file. The FLV file may be embedded in the SWF file. In other embodiments, other suitable formats for the first and second video objects may be used. The highlight event may be of substantially shorter duration than a total playing time for the first video object. For example, the highlight event may last 3 frames while the first video objects includes thousands of frames requiring several minutes or even hours to play. The highlight even may, in the alternative, be longer than three frames. Each highlight event may be synchronized to the FLV file or other video file using a cue point embedded in the FLV or other file. The second video object may be defined by a definition tag in an SWF file and controlled by at least one control tag in the same SWF file. The definition tag may define any suitable highlight object, such as a shape or a bitmap. The control tag may specify a number of frames the highlight shape appears. The highlight may be configured to appear as a transient object flickering near the visible object shape, such as over or adjacent to the highlighted object.

Method 1400 further comprises serving 1406 the video content to a client device to cause a video output. For example, in response to a client request, video content may be delivered using embedded video within an SWF file formatted for play on a FLASH player, or other video format for play using a client media player. A suitable format and player should include the ability to handle separately-encoded video clips and highlight content, to avoid the need to hard encode highlight features into produced video content. In the alternative, video content may be delivered using progressive download FLV files. Another alternative may include streaming video content from a media server.

Method 1400 may further comprise serving contextual information to the client configured for display in a second window of the client video display. The second window may comprise a content window displayed next to the first video frame window by a client media player application. In the alternative, or in addition, the contextual information may configured for display in a window of a separate application, such as in a window or a Web browser application. The contextual information may provide further details regarding the visible object and may be configured to appear in the second window beginning at a time substantially synchronized with the highlight event. In embodiments wherein the visible object shape in the principal video clip depicts a commercial product, the contextual information may comprise advertising for the commercial product. In other embodiments, contextual information may include further details of an informational nature concerning objects appearing in the principal video clip. Contextual information may further comprise a hyperlink to a site providing further information about the commercial product.

Other features and objects served to participating clients may include a video progress bar, a product navigation bar, or any other feature as described above in conjunction with FIGS. 3-12. Additional features and objects may further be added as may be apparent to one of ordinary skill.

Having thus described a preferred embodiment of broadband video with synchronized highlight signals, it should be apparent to those skilled in the art that certain advantages of the foregoing method and apparatus have been achieved. It should also be appreciated that various modifications, adaptations, and alternative embodiments thereof may be made within the scope and spirit of the present technology.

What is claimed is:

1. A method for providing an interactive video display output, comprising:
serving video content to a client device to cause a video output, the video content comprising first and second video objects that are not encoded together and that are configured for display together in overlapping layers in a first window of a client video display, wherein at least one visible object shape in the first video object is associated with a fitted highlight in the second video object, and wherein the highlight is synchronized to appear with and draw attention to the visible object shape during a highlight event of substantially shorter duration than a total playing time for the first video object.

2. The method of claim 1, wherein the video content comprises an SWF file, and the first video object comprises an FLV file embedded in the SWF file.

3. The method of claim 2, wherein the highlight is synchronized to the FLV file using a cue point embedded in the FLV file.

4. The method of claim 2, wherein the second video object is defined by at least one definition tag in the SWF file and controlled by at least one control tag in the SWF file.

5. The method of claim 4, wherein the at least one definition tag defines an object selected from a shape and a bitmap.

6. The method of claim 1, wherein the video content further comprises a video progress bar object on which the highlight event is indicated by a marker.

7. The method of claim 1, further comprising serving contextual information to the client for display in a second window of the client video display, the contextual information providing further details regarding the visible object and configured to appear in the second window beginning at a time substantially synchronized with the highlight event.

8. The method of claim 7, wherein the visible object shape depicts a commercial product and the contextual information comprises advertising for the commercial product.

9. The method of claim 8, wherein the contextual information further comprises a hyperlink to a site providing further information about the commercial product.

10. The method of claim 1, wherein the highlight is configured to appear as a transient object flickering near the visible object shape.

11. A computer-readable media comprising video content configured to cause a client to display the video content on a display screen, the video content comprising first and second video data that are not encoded together and that are configured for display together in a first window of the display screen, wherein at least one frame in the first video data is associated with a highlight in the second video data, and wherein the highlight is synchronized to appear with and draw attention to a predetermined object appearing in the at least one frame during a highlight event of substantially shorter duration than a total playing time for the first video data.

12. The computer-readable media of claim 11, wherein the video content comprises an SWF file, and the first video data comprises an FLV file embedded in the SWF file.

13. The computer-readable media of claim 12, wherein the highlight is synchronized to the FLV file using a cue point embedded in the FLV file.

14. The computer-readable media of claim 12, wherein the second video data is defined by at least one definition tag in the SWF file and controlled by at least one control tag in the SWF file.

15. The computer-readable media of claim 14, wherein the at least one definition tag defines an object selected from a shape and a bitmap.

16. The computer-readable media of claim 11, wherein the video content further comprises a video progress bar on which the highlight event is indicated by a marker.

17. The computer-readable media of claim 11, further comprising instructions for requesting contextual information from a remote host for display in a second window of the client video display, the contextual information providing further details regarding the visible object and configured to appear in the second window beginning at a time substantially synchronized with the highlight event.

18. The computer-readable media of claim 17, wherein the visible object shape depicts a commercial product and the contextual information comprises advertising for the commercial product.

19. The computer-readable media of claim 18, wherein the contextual information further comprises a hyperlink to a site providing further information about the commercial product.

20. The computer-readable media of claim 11, wherein the highlight is configured to appear as a transient object flickering near the visible object shape.
